(19) United States
(12) Patent Application Publication
(10) Pub. No.: US 2019/0181498 A1
(43) Pub. Date: Jun. 13, 2019

(54) PROCESS FOR PREPARING THIN FILMS OF SOLID ELECTROLYTES COMPRISING LITHIUM AND SULFUR

(71) Applicant: BASF SE, Ludwigshafen am Rhein (DE)

(72) Inventors: Michael Baecker, Rheinbach (DE); Daniel Waldmann, Ludwigshafen (DE); Joern Kulisch, Ludwigshafen (DE); Johan ter Maat, Ludwigshafen (DE); Pascal Hartmann, Ludwigshafen (DE); Mariusz Mosiadz, Rheinbach (DE); Annika Baumann, Rheinbach (DE); Lukas Ewald, Rheinbach (DE)

(21) Appl. No.: 16/309,500

(22) PCT Filed: Jun. 7, 2017
(86) PCT No.: PCT/EP2017/063828

§ 371 Date: Dec. 13, 2018

(30) Foreign Application Priority Data
Jun. 13, 2016 (EP) 16174196.2

(51) Int. Cl. H01M 10/0562; H01M 10/0525

(52) U.S. Cl. CPC H01M 10/0562; H01M 2300/0068; H01M 10/0525

(57) ABSTRACT

Described herein is a process for preparing a thin film including a solid electrolyte, which includes lithium and sulfur.

The present invention relates to a process for preparing a thin film comprising a solid electrolyte, which comprises lithium and sulfur.

Secondary batteries, accumulators or “rechargeable batteries” are just some embodiments by which electrical energy can be stored after generation and used when required. Owing to the significantly better power density, there has been in recent times a move away from the water-based secondary batteries toward development of those batteries in which the charge transport in the electrical cell is accomplished by lithium ions.

However, the energy density of conventional lithium ion accumulators, which have a carbon anode, a cathode based on metal oxides and a non-aqueous electrolyte comprising organic solvents, is limited. New horizons with regard to energy density have been opened up by systems employing a lithium anode such as all-solid-state lithium battery comprising a metallic lithium anode and a solid lithium-ion conducting inorganic electrolyte.

J. Am. Ceram. Soc. 93 [3] 765-768 (2010) describes the preparation of highly lithium-ion conductive Li₂S—P₂S₅ thin-film electrolytes using pulsed laser deposition (PLD).

Chem. Lett. 2013, 42, 1435-1437 discloses the formation of Li₂S—P₂S₅ solid electrolyte from N-methylformamide solution.

J. Power Sources 248 (2014), 939-942 describes the preparation of Li₂S—P₂S₅ solid electrolyte from N-methylformamide solution and application for all-solid-state lithium battery. Electrode-solid electrolyte composite materials for all-solid-state lithium batteries were prepared by coating of the Li₂S—P₂S₅ solid electrolyte onto LiCoO₂ particles using a N-methylformamide (NMF) solution of 80Li₂S.20P₂S₅ (mol %) solid electrolyte.

JP 2014-191899 discloses a liquid solution for formation of a solid electrolyte-containing layer of an all-solid type lithium secondary battery. The solution comprises a solid electrolyte expressed by Li₂S-MₓS_{y}, wherein M is selected from P, Si, Ge, B, Al and Ga and x and y are figures which present a stoichiometric ratio according to the kind of M, and an organic solvent, which can dissolve the solid electrolyte.

WO 2015/050131 A1 discloses a solution for forming a layer that contains a solid electrolyte for all-solid-state alkali metal secondary batteries. The solution contains a component derived from A₂S and MₓS_{y}, which are starting materials for solid electrolyte production, wherein A is selected from among Li and Na, M is selected from among P, Si, Ge, B, Al and Ga, and x and y are numbers, that provide a stoichiometric ratio according to the kind of M. The solution further comprises a non-polar organic solvent and a polar organic solvent having a polarity value higher than that of the non-polar organic solvent by 0.3 or more.

Proceeding from this prior art, an object of the invention was to provide an economic and reproducible process for the formation of thin films of solid electrolytes, which comprise lithium and sulfur, wherein the films have desired properties such as sufficient ion-conductivity, less defects, high homogeneity or high imperviousness.

This object is achieved by a process for preparing a thin film comprising a solid electrolyte, which comprises lithium and sulfur, comprising the process steps of
a) forming a layer by depositing of a liquid mixture, which comprises one or more compounds, which comprise together lithium and sulfur, and at least one organic solvent, on a substrate, which is heated to a temperature in the range from 0° C. to 200° C.,
b) keeping the formed layer of process step a) at a temperature in the range from 0° C. to 200° C. for a period in the range from 0.01 h to 24 h, and
c) heating the layer obtained in process step b) at a temperature in the range from 150° C. to 400° C. for a period in the range from 0.01 h to 24 h.

This object is also achieved by a process for preparing a thin film comprising a solid electrolyte, which comprises lithium and sulfur, comprising the process steps of
a) forming a layer by depositing of a liquid mixture, which comprises one or more compounds, which comprise together lithium and sulfur, and at least one organic solvent, on a substrate, which is heated to a temperature in the range from 50° C. to 110° C.,
b) keeping the formed layer of process step a) at a temperature in the range from 50° C. to 110° C. for a period in the range from 0.1 h to 24 h, preferably 0.1 h to 2 h, and
c) heating the layer obtained in process step b) at a temperature in the range from 180° C. to 400° C., preferably from 200° C. to 350° C., for a period in the range from 0.5 h to 24 h, preferably 0.5 to 2 h.

The thickness of the films prepared by the inventive process can be varied in a wide range depending on the desired value for the intended application. The different measures, which can be applied, in order to obtain a certain film thickness are generally known to the person skilled in the art. Suitable measures for varying the thickness of the film are for example variation of the concentration of the liquid mixture, in particular a solution, or the volume of the liquid mixture, which is deposited.

Preferably the thin film has a thickness in the range from 5 nm to 50 μm, more preferably in the range from 100 nm to 20 μm, most preferably in the range from 500 nm to 10 μm, in particular in the range from 700 nm to 2 μm.

In one embodiment of the present invention, the process is characterized in that the thin film has a thickness in the range from 5 nm to 50 μm, preferably in the range from 100 nm to 20 μm, in particular in the range from 500 nm to 10 μm.

The thin film prepared in the inventive process might comprise beside the solid electrolyte, which comprises lithium and sulfur, further components, including residual solvent, such as NMF, or reaction products thereof, alternative solid electrolytes such as garnets in form of particles, electroactive materials, such as particles of LTO, inert materials, such as particles of alumina or silica, surfactants or polymers, as long as the desired properties of the film do not deteriorate. Preferably the film is characterized in that the mass fraction of the solid electrolyte, which comprises lithium and sulfur, in the thin film is in the range from 0.5 up to 1, more preferably in the range from 0.90 up to 1, in particular in the range from 0.95 up to 1.

In one embodiment of the present invention, the process is characterized in that the mass fraction of the solid electrolyte, which comprises lithium and sulfur, in the thin film is in the range from 0.95 up to 1.

The solid electrolyte, which comprises lithium and sulfur, usually comprises lithium in form of lithium cations (Li⁺) and sulfur preferably in form of sulfides (S²⁻) or polysulfides (Sₓ²⁻=S²⁻+S⁰ₓ₋₁), in particular in form of sulfides. A small portion of the sulfur atoms of the solid electrolyte might be also in a formal oxidation state in the range from +VI to 0, for example thiosulfate (+VI and −II), polythionates (+V, 0) or dithionite (+III).

The solid electrolyte, which comprises lithium and sulfur, usually comprises at least one further element of the periodic table of the elements. Preferably, the solid electrolyte, which comprises lithium and sulfur, further comprises at least one element of group 2, group 4, group 8, group 12, group 13, group 14, group 15 or group 17 of the periodic table or oxygen, selenium or tellurium.

Many elements are ubiquitous. For example, sodium, potassium and chloride are detectable in certain very small proportions in virtually all inorganic materials. In the context of the present invention, proportions of less than 0.1% by weight of cations or anions are disregarded. Any solid electrolyte comprising less than 0.1% by weight of sodium is thus considered to be sodium-free in the context of the present invention. Correspondingly, any solid electrolyte comprising less than 0.1% by weight of chloride ions is considered to be chloride-free in the context of the present invention.

In one embodiment of the present invention, the process is characterized in that the solid electrolyte, which comprises lithium and sulfur, is defined by general formula (I)

(Li₂Sₛ)ₓ(LiₙXⁿ⁻)ᵥ(P₂Sₜ₋ᵤOᵤ)_{y}(M^{m+}ₒZ^{o-}ₘ)_{w} (I)

in which the variables are each defined as follows:
M is an element of group 2, group 4, group 8, group 12 or group 13 of the periodic table or Si, Ge, Sn, Pb, As, Sb or Bi or a mixture thereof, preferably Mg, Ti, Fe, Zn, B, Al, Ga, Si, Ge or Sn or a mixture thereof, in particular B, Si, Ge or Sn or a mixture thereof,
X is N, O, a halogen or a mixture thereof, preferably O, Br or I, in particular O,
Z is N, O, S, a halogen or a mixture thereof, preferably O, S, Br or I, in particular O or S,
m is 2, 3, 4 or 5 in case of a single element M in a single oxidation state or a rational number in the range from 2 to 5 calculated on basis of the different oxidation states of different elements M and the molar ratio of said different elements M,
n is 1 for halogen, 2 for O (oxygen) or 3 for N (nitrogen) or a rational number in the range from 1 to 3 calculated on basis of the molar ratio of said different elements X,
o is 1 for halogen, 2 for O (oxygen), 2 for S (sulfur) or 3 for N (nitrogen) or a rational number in the range from 1 to 3 calculated on basis of the molar ratio of said different elements Z,
s is a rational number from 1 to 8, preferably 1 to 2, in particular 1,
t is a rational number from 0.5 to 5, preferably 1.5 to 5, more preferably 3 to 5, in particular 5,
u is a rational number from 0 to t, preferably 0 to 3/5 t, more preferably 0 to 1/5 t, in particular 0,
x is in the range from 0.05 to 0.95, preferably 0.1 to 0.9, in particular 0.15 to 0.85,
y is in the range from 0 to 0.95, preferably 0.1 to 0.5, in particular 0.15 to 0.35,
is in the range from 0 to 0.95, preferably 0 to 0.8, in particular 0 to 0.7,
w is in the range from 0 to 0.95, preferably 0 to 0.8, in particular 0 to 0.7,
wherein x+y+v+w=1.

General formula (I) represents only a stoichiometric composition of a solid electrolyte. The different parts of the formulae, that is (Li₂ Sₛ), (Liₙ Xⁿ⁻), (P₂ Sₜ₋ᵤ Oᵤ) and (M^{m+}ₒZ^{o-}ₘ), are neither necessarily starting materials for the preparation of the solid electrolyte nor necessarily detectable phases of the solid electrolyte.

Non limiting examples of solid electrolytes, which comprises lithium and sulfur and which are defined by general formula (I) are for example Li₁₀GeP₂S₁₂, Li₁₀SiP₂S₁₂, Li₁₀SnP₂S₁₂, Li₇P₃S₁₁, Li₇P₃O₂S₉, Li₈P₂S₉, Li₃P₁S₄, Li₈P₂O₁S₈, Li₉P₁S₇, Li₉P₁BrO_{0.5}S₆, Li₄P₂S₆, Li₄P₂S₇, Li₆PS₅Cl, Li₇P₂S₈I, Li₄SnS₄, Li₄SiS₄.

In one embodiment of the present invention, the process is characterized in that the solid electrolyte, which comprises lithium and sulfur, further comprises phosphorous. In this case the variables x, y, v and w of above-defined general formula (I) are preferably defined as follows:
x is in the range from 0.05 to 0.95, preferably 0.1 to 0.9, in particular 0.65 to 0.85,
y is in the range from 0.05 to 0.95, preferably 0.1 to 0.5, in particular 0.15 to 0.35,
v is in the range from 0 to 0.90, preferably 0 to 0.8, in particular 0 to 0.2,
w is in the range from 0 to 0.90, preferably 0 to 0.8, in particular 0 to 0.2,

In another embodiment of the present invention, the process is characterized in that the solid electrolyte, which comprises lithium and sulfur, further comprises nitrogen, oxygen or a halogen, more preferably oxygen, bromine or iodine, in particular oxygen. In this case the variables x, y, v and w of above-defined general formula (I) are preferably defined as follows:
x is in the range from 0.05 to 0.95, preferably 0.1 to 0.9, in particular 0.15 to 0.85,
y is in the range from 0 to 0.95, preferably 0 to 0.5, in particular 0 to 0.35,
v is in the range from 0 to 0.95, preferably 0 to 0.9, in particular 0 to 0.85,
w is in the range from 0 to 0.95, preferably 0 to 0.9, in particular 0 to 0.85,
wherein v+x is in the range from 0.05 to to 0.95, preferably 0.1 to 0.9, in particular 0.15 to 0.85.

In another embodiment of the present invention, the process is characterized in that the solid electrolyte, which comprises lithium and sulfur, further comprises phosphorous and an element selected from the group consisting of nitrogen, oxygen and halogen, more preferably selected from the group consisting of oxygen, bromine and iodine, in particular oxygen. In this case the variables x, y, v and w of above-defined general formula (I) are preferably defined as follows:
x is in the range from 0.05 to 0.9, preferably 0.1 to 0.85, in particular 0.15 to 0.8,
y is in the range from 0.05 to 0.9, preferably 0.05 to 0.5, in particular 0.05 to 0.35,
v is in the range from 0 to 0.9, preferably 0 to 0.85, in particular 0 to 0.2,
w is in the range from 0 to 0.9, preferably 0 to 0.85, in particular 0 to 0.2,
wherein v+x is in the range from 0.05 to to 0.9, preferably 0.1 to 0.85, in particular 0.15 to 0.8.

The solid electrolyte, which comprises lithium and sulfur, can show different degrees of crystallinity depending on the chemical composition of the solid electrolyte and on the methods and conditions of its preparation. The solid electrolyte, which comprises lithium and sulfur, may be a fully amorphous, partially crystalline or fully crystalline material.

The thin film can be prepared on a wide variety of substrates and in a wide variety of shapes, depending on the size and shape of the substrate whereon the thin layer is formed, or on the intended use of the thin film. The thin film can be produced, for example, in the form of continuous belts which are processed further by the battery manufacturer. It is also possible to prepare separate sheets of the thin film of different areas, preferably in the range from 0.01 cm² to 10 m². The thin film can coat either the entire substrate area or only part of it. The thin film can also be formed directly around small particles, like particles of typical cathode materials. In this case the thin film represents a shell around a regular or irregular shaped particle. The average diameter of such particles of cathode materials are usually in the range from 50 nm to 500 μm, more preferably in the range from 200 nm to 100 μm.

In one embodiment of the present invention, the process is characterized in that the thin film, which is prepared on the substrate, has an area in the range from 0.01 cm² to 10 m².

The thin films prepared in the inventive process show a conductivity in the range from 1*10⁻⁶ S/cm to 5*10⁻¹ S/cm, more preferably 2*10⁻⁶ S/cm to 5*10⁻³S/cm, much more preferably 3*10⁻⁶ S/cm to 5*10⁻⁴S/cm, in particular in the range from 5*10⁻⁶ S/cm to 2*10⁻⁵S/cm.

In process step (a) of the inventive process a layer is formed by depositing of a liquid mixture, which comprises one or more compounds, which comprise together lithium and sulfur, and at least one organic solvent, on a substrate, which is heated to a temperature in the range from 0° C. to 200° C.

Depositing of liquid mixtures on a substrate is a well-known action. Preferred deposition methods in case of process step a) are selected from spin coating, casting, doctor blading, slot die coating, dip coating, spray coating, screen printing and inkjet printing, more preferably selected from drop casting and inkjet printing, in particular inkjet printing.

In one embodiment of the present invention, the process is characterized in that the deposition of the liquid mixture in process step a) is done by inkjet printing.

Since a liquid mixture is deposited on a substrate, the layer initially formed is liquid. The formation of a continuous and even liquid layer regarding thickness depends on the interaction between the liquid mixture and the surface of the substrate and on the applied deposition method.

The liquid mixture, which is deposited on the substrate in process step a), comprises one or more compounds, which comprise together lithium and sulfur, and at least one organic solvent.

The organic solvent usually dissolves certain amounts of the used one or more compounds. In certain cases mixture of two or more solvents shows even better solubility for the used one or more compounds. Examples of suitable organic solvents are non-polar solvents and polar solvents, that is to say polar aprotic or polar protic solvents, such as pyridine, dimethylsulfoxid, acetonitrile, ethers like glymes such as 1,2-dimethoxyethane, 1,4-dioxane or THF, amides such as N-methyl-2-pyrrolidone (NMP), N-ethyl-2-pyrrolidone (NEP), N-methylformamide (NMF) or N,N-dimethylformamide (DMF), acetals such as 1,3-dioxolane, alcohols such as ethanol or methanol, and the corresponding thio derivaties such as thioethers, thioamides, dithioacetals and thiols, and mixtures of the above-mentioned organic solvents. Particularly preferred is N-methylformamide as solvent.

In one embodiment of the present invention, the process is characterized in that the organic solvent is N-methylformamide.

The original stoichiometric composition of the one or more compounds, which comprise together lithium and sulfur and which are used in process step a) can deviate from the final stoichiometric composition of the solid electrolyte, which is formed in the inventive process. This difference is due to possible reactions of the one or more compounds with components of the liquid mixture such as solvent molecules or molecules present in the environment of the deposited layer and present during one of the film formation steps, like gas molecules such as O₂, H₂O or CO₂. It is also possible to add purposely reactive molecules such as F₂, Cl₂, Br₂, I₂ or SO₃ during the above-described process steps.

In one embodiment of the present invention, the process is characterized in that the composition of the one or more compounds, which comprise together lithium and sulfur, of the liquid mixture, which is deposited in process step a), is identical or different to the composition of the solid electrolyte.

The composition of the one or more compounds, which comprise together lithium and sulfur, of the liquid mixture, which is deposited in process step a), usually comprises at least one further element of the periodic table of the elements. Preferably, the one or more compounds, which comprise together lithium and sulfur, of the liquid mixture, which is deposited in process step a), further comprises at least one element of group 2, group 4, group 8, group 12, group 13, group 14, group 15 or group 17 of the periodic table or oxygen, selenium or tellurium.

Many elements are ubiquitous. For example, sodium, potassium and chloride are detectable in certain very small proportions in virtually all inorganic materials. In the context of the present invention, proportions of less than 0.1% by weight of cations or anions are disregarded. Any composition of the one or more compounds, which comprise together lithium and sulfur, comprising less than 0.1% by weight of sodium is thus considered to be sodium-free in the context of the present invention. Correspondingly, any composition of the one or more compounds, which comprise together lithium and sulfur, comprising less than 0.1% by weight of chloride ions is considered to be chloride-free in the context of the present invention.

In one embodiment of the present invention, the process is characterized in that the composition of the one or more compounds, which comprise together lithium and sulfur, of the liquid mixture, which is deposited in process step a), further comprises phosphorous.

In another embodiment of the present invention, the process is characterized in that the composition of the one or more compounds, which comprise together lithium and sulfur, of the liquid mixture, which is deposited in process step a), further comprises nitrogen, oxygen or a halogen, more preferably oxygen, bromine or iodine, in particular oxygen.

In one embodiment of the present invention, the process is characterized in that the composition of the one or more compounds, which comprise together lithium and sulfur, of the liquid mixture, which is deposited in process step a), is defined by general formula (Ia)

(Li₂Sₛ)_{x′}(LiₙXⁿ⁻)_{v′}(P₂Sₜ₋ᵤOᵤ)_{y′}(M^{m+}ₒZ^{o-}ₘ)_{w′} (la)

in which the variables are each defined as follows:
M is an element of group 2, group 4, group 8, group 12 or group 13 of the periodic table or Si, Ge, Sn, Pb, As, Sb or Bi or a mixture thereof, preferably Mg, Ti, Fe, Zn, B, Al, Ga, Si, Ge or Sn or a mixture thereof, in particular B, Si, Ge or Sn or a mixture thereof,
X is N, O, a halogen or a mixture thereof, preferably O, Br or I, in particular O,
Z is N, O, S, a halogen or a mixture thereof, preferably O, S, Br or I, in particular O or S,
m is 2, 3, 4 or 5 in case of a single element M in a single oxidation state or a rational number in the range from 2 to 5 calculated on basis of the different oxidation states of different elements M and the molar ratio of said different elements M,
n is 1 for halogen, 2 for O (oxygen) or 3 for N (nitrogen) or a rational number in the range from 1 to 3 calculated on basis of the molar ratio of said different elements X,
o is 1 for halogen, 2 for O (oxygen), 2 for S (sulfur) or 3 for N (nitrogen) or a rational number in the range from 1 to 3 calculated on basis of the molar ratio of said different elements Z,
s is a rational number from 1 to 8, preferably 1 to 2, in particular 1,
t is a rational number from 0.5 to 5, preferably 1.5 to 5, more preferably 3 to 5, in particular 5,
u is a rational number from 0 to t, preferably 0 to 3/5 t, more preferably 0 to 1/5 t, in particular 0,
x′ is in the range from 0.05 to 0.95, preferably 0.1 to 0.9, in particular 0.15 to 0.85,
y′ is in the range from 0 to 0.95, preferably 0.1 to 0.5, in particular 0.15 to 0.35,
v′ is in the range from 0 to 0.95, preferably 0 to 0.8, in particular 0 to 0.7,
w′ is in the range from 0 to 0.95, preferably 0 to 0.8, in particular 0 to 0.7,
wherein x′+y′+v′+w′=1.

The necessary starting materials for the preparation of a solid electrolyte of general formula (I) or a composition of general formula (Ia) cannot be directly deduced from the different parts of the formulae, that is (Li₂ Sₛ), (Liₙ Xⁿ⁻), (P₂ Sₜ₋ᵤ Oᵤ) and (M^{m+}ₒ Z^{o-}ₘ), and their respective stoichiometry.

The liquid mixture, which is deposited on a substrate in process step a) can be a solution, which is a single-phase system, or a dispersion, that is an emulsion or a suspension, which is two-phase or multi-phase system. The nature of the liquid mixture depends on the interaction, e.g. solubility, of the different components of the liquid mixture, such as the compounds, which comprise together lithium and sulfur, and the organic solvents. The liquid mixture, which is deposited in process step a) is preferably a solution.

In one embodiment of the present invention, the process is characterized in that the liquid mixture, which is deposited in process step a) is a solution.

The mass fraction of the one or more compounds, which comprise together lithium and sulfur, in the deposited liquid mixture can be varied in a wide range.

In case the liquid mixture is a solution, the mass fraction of the one or more compounds, which comprise together lithium and sulfur, depends on the solubility of said one or more compounds, which comprise together lithium and sulfur, in the solution. Preferably the mass fraction of the one or more compounds, which comprise together lithium and sulfur, in the deposited solution is in the range from 0.01 to 0.25, more preferably in the range from 0.02 to 0.12, in particular in the range from 0.03 to 0.1. In case the one or more compounds, which comprise together lithium and sulfur, are (Li₂S)_{0.7} (P₂S₅)_{0.3} the mass fraction of these compounds in the deposited liquid mixture is preferably in the range from 0.03 to 0.15.

In one embodiment of the present invention, the process is characterized in that in process step a) the mass fraction of the one or more compounds, which comprise together lithium and sulfur, in the deposited liquid mixture is in the range from 0.02 to 0.12.

The volume of the liquid mixture, preferably the volume of a solution, which is deposited on a defined area of substrate can be varied in a wide range. Preferably the liquid mixture is deposited on the substrate in an amount in the range from 0.1 μl/cm² to 50 μl/cm², preferably in the range from 0.5 μl/cm² to 10 μl/cm², more preferably in the range from 1 μl/cm² to 5 μl/cm².

In one embodiment of the present invention, the process is characterized in that in process step a) the one or more compounds, which comprise together lithium and sulfur, are (Li₂S)_{0.7} (P₂S₅)_{0.3}, the mass fraction of these compounds in the deposited liquid mixture is in the range from 0.03 to 0.15 and the liquid mixture is deposited on a substrate in an amount in the range from 1 μl/cm² to 5 μl/cm², preferably 1 μl/cm² to 3 μl/cm².

The liquid mixture, which is deposited on the substrate in process step a), might comprise beside the dissolved or undissolved one or more compounds, which comprise together lithium and sulfur, and at least one organic solvent further components, including alternative solid electrolytes such as garnets in form of particles, electroactive materials, such as particles of LTO, inert materials, such as particles of alumina or silica, surfactants or polymers. Preferably the liquid mixture remains stable throughout the process steps of the present invention in order to avoid the formation of films with thickness and/or composition variations.

Preferably the liquid mixture is characterized in that the sum of the mass fractions of the one or more compounds, which comprise together lithium and sulfur, and of the organic solvents in the solution is in the range from 0.5 up to 1, more preferably is in the range 0.90 up to 1, much more preferably in the range from 0.95 up to 1, in particular in the range from 0.98 up to 1.

The substrate, on which the layer of the liquid mixture is deposited, can be varied in a wide range. The substrate preferably ranges from particles of typical cathode materials, metal foils, tapes of a cathode comprising current collector such as an aluminum foil and a layer comprising an electroactive cathode material such as lithium titanium oxide (LTO, e.g. Li₄Ti₅O₁₂), lithium iron phosphate (LFP, e.g. LiFePO₄) or lithium nickel cobalt manganese oxide (NCM-abc, e.g. NCM-111), to all-solid-state cathodes comprising at least a solid electrolyte and a cathode active material. The layer of the liquid mixture can be deposited on substrates ranging from extremely smooth substrates, e.g. Au/Si wafers, to substrates that are rough and porous on a microscopic scale. In case, the substrate has a porous structure or components of the substrate are porous, voids, which are present in the substrate are at least partly filled by the deposited liquid mixture, in particular when the liquid mixture is a solution.

The substrate, on which the liquid mixture is deposited in process step a), is heated to a temperature in the range from 0° C. to 200° C., preferably in the range from 30° C. to 150° C., in particular in the range from 50° C. to 110° C. During the deposition of the liquid mixture, the temperature of the substrate is preferably kept constant. A temperature of the substrate is chosen, which allows the liquid mixture to spread evenly on the surface of the substrate in order to form an even liquid layer. Further, the temperature of the substrate in process step a) is preferably below the boiling point of the organic solvent of the liquid mixture, in order to avoid a rapid and/or premature removal of the organic solvent. In case the liquid mixture is a solution of (Li₂S)_{0.7} (P₂S₅)_{0.3} in N-methylformamide, the substrate is preferably heated to a temperature in the range from 70° C. to 90° C.

In process step b) the formed layer of process step a) is kept at a temperature in the range from 0° C. to 200° C., preferably in the range from 30° C. to 150° C., in particular in the range from 50° C. to 110° C., for a period in the range from 0.01 h to 24 h, preferably in the range from 0.1 h to 2 h, more preferably in the range from 0.25 h to 1.3 h, in particular in range from 0.4 h to 0.6 h. In process step b) the temperature is preferably kept constant. Even though the temperatures of process step a) and process step b) can differ from each other, it is preferred keeping the temperature in both process steps almost the same, with a variation in the range from 0 K to 10 K. In process step b) preferably most of the solvent evaporates and the initially liquid film becomes a solid, smooth, crack-free and completely transparent, vitreous film. The decreasing content of organic solvents can be easily monitored by FT-IR analysis. Process step b) can be considered as a pre-drying step, wherein preferably more than 50 wt.-%, more preferably more than 75 wt.-%, in particular more than 90 wt.-% of the initial amount of solvent is evaporated. In case the formed layer was obtained by depositing liquid mixture of a solution of (Li₂S)_{0.7} (P₂S₅)_{0.3} in N-methylformamide, the layer is preferably kept at a temperature in the range from 70° C. to 90° C. for 0.1 h to 3 h, preferably for 0.5 h to 2 h.

In the process step c) the layer obtained in process step b) is heated at a temperature in the range from 150° C. to 400° C., preferably in the range from 180° C. to 400° C., more preferably in the range from 180° C. to 270° C., in particular in the range from 200° C. to 250° C., for a period in the range from 0.01 h to 24 h, preferably in the range from 0.1 h to 4 h, more preferably in the range from 0. 5 h to 2 h, in particular in the range from 0.75 h to 1.5 h. In case the layer obtained in process step b) originates from depositing a liquid mixture of a solution of (Li₂S)_{0.7} (P₂S₅)_{0.3} in N-methylformamide in process step a), said layer is preferably heated in process step c) at a temperature in the range from 200° C. to 350° C., preferably in the range from 250° C. to 300° C. for a period in the range from 0.5 h to 2 h.

The temperature, which is reached in process step c), is usually higher than the temperatures applied in process steps a) and b). Preferably, the final temperature in process step c) is at least 20 K, more preferably at least 40 K, in particular at least 60 K higher than the temperatures applied in process steps a) and b). The temperature, which is reached in process step c), is usually in the range of the boiling point of the least volatile organic solvent, which was used in process step a). Preferably the temperature, which is reached in process step c), is in the range from the boiling point of the least volatile organic solvent minus 10 K to the boiling point of the least volatile organic solvent plus 50 K, more preferably is in the range from the boiling point of the least volatile organic solvent minus 5 K to the boiling point of the least volatile organic solvent plus 30 K.

The heating rate used in process step c) in order to reach the final temperature can be varied in a wide range. Preferably, the temperature of process step c) is reached by a heating rate in the range from 0.5 K/min to 200 K/min, more preferably in the range from 2 K/min to 50 K/min, much more preferably in the range from 5 K/min to 20 K/min, in particular in the range from 9 K/min to 11 K/min.

In case the layer obtained in process step b) originates from depositing a liquid mixture of a solution of (Li₂S)_{0.7} (P₂S₅)_{0.3} in N-methylformamide in process step a), the heating rate used in process step c) in order to reach the final temperature is preferably in the range from 1 K/min to 15 K/min, more preferably in the range from 2 K/min to 10 K/min.

In one embodiment of the present invention, the process is characterized in that the temperature of process step c) is reached by a heating rate in the range from 2 K/min to 50 K/min.

The boiling point of a liquid depends on the pressure. The pressure applied during process steps a), b) and c) can be varied in a wide range. Preferably the layer formed and thermally treated in process steps a), b) and c) is kept at a pressure in the range from 0.1 kPa to 1000 kPa, more preferably in the range from 10 kPa to 200 kPa, in particular in the range from 60 kPa to 110 kPa. Preferably a pressure below 60 kPa is applied in case of high boiling solvents with a boiling point above 220° C. at 100 kPa, whereas a pressure in the range from 60 kPa to 1000 kPa is preferably applied in case of solvents with a boiling point below 220° C. at 100 kPa.

In one embodiment of the present invention, the process is characterized in that the layer is kept at a pressure in the range from 10 kPa to 200 kPa during process steps a), b) and c).

The time needed for evaporating a solvent at a given temperature varies depending on the condition applied. Dynamic conditions, e.g. atmosphere circulation or constant exchange of the atmosphere in order to remove solvent vapors continuously, decrease the time needed for evaporating a solvent when compared to static methods, wherein the atmosphere e.g. does not moved or is not exchanged (stagnant atmosphere).

Since the solid electrolytes, which comprise lithium and sulfur, in particular solid electrolytes defined by above-given general formula (I) are highly susceptible to humidity, the handling is usually done under dry gas atmosphere, like dry air with a dewpoint <−20° C., preferably <−60° C., or under an inert gas atmosphere, e.g. in an argon atmosphere or in a nitrogen atmosphere.

The inventive process represents an economic and reproducible process, which gives access to cost-effective lithium-ion conducting films of high quality and which can be easily transferred to large scale production. The films prepared by the inventive process show desired properties like a crack- and pinhole-free morphology and good lithium-ion conductivity.

The thin film generated in the inventive process can receive further treatments which are standard technologies in battery manufacturing, in particular calendaring to densify the thin film, to calibrate the thickness of the film and to unify the thin film with cathode and/or anode tapes into a battery cell. The film can, for example, be generated on a temporary substrate and is then brought onto a cathode or anode tape by transfer lamination.

The invention is illustrated by the examples which follow, but these do not restrict the invention.

Figures in percent are each based on % by weight, unless explicitly stated otherwise.

I Preparation of Thin Films of (Li₂S)_{0.7}(P₂S₅)_{0.3},

### I.1 EXAMPLE 1 (INVENTIVE)

A 70Li₂S.30P₂S₅ (mol. %) powder, prepared according to Mizuno et al. Adv. Mater. 2005, 17, 918-921, was dissolved in N-methylformamide (NMF) with 1 h long vigorous stirring in a pure Ar atmosphere to form clear and yellow 4% (by weight) solution. Within the first 3 h from the synthesis 7.5 μL of precursor solution after filtration through a 0.45 μm nylon syringe filter was deposited by drop-casting onto a cleaned and pre-heated to 100° C. Au/Si wafer as a substrate. The substrate cleaning procedure consisted of ultra-sonication in an organic solvent followed by plasma etching. The coated substrate was kept at this temperature for another 0.5 h to remove most of the solvent. After the completed pre-drying step, the temperature was ramped with the heating ramp of 10° C./min to 215° C. and maintained for another 1 h to ensure complete solvent removal. Finally, the 1.1 μm thick sulfide glass film was naturally cooled to room temperature in an Ar glove box.

### I.2 EXAMPLE 2 (COMPARATIVE)

A clear 70Li₂S.30P₂S₅ precursor solution was prepared according to the Example 1 then drop-casted at room temperature. The coated substrate did not undergo pre-drying step according to the Example 1 instead, the temperature was directly ramped with 20° C./min to 150° C. and maintained for 3 h in vacuum to match the deposition procedure described in JP 2014-191899.

### I.3 EXAMPLE 3 (COMPARATIVE)

A 70Li₂S.30P₂S₅ powder of Example 1 was dissolved in anhydrous methanol (MeOH) with 1 h long vigorous stirring in a pure N₂ atmosphere to form clear and yellow 4% (by weight) solution. Within the first 3 h from the synthesis 7.5 μL of precursor solution after filtration through a 0.45 μm nylon syringe filter was deposited by drop-casting onto a clean substrate of Example 1 and maintained at room temperature. The coated substrate was then heated to the temperature of 215° C. with the heating ramp of 6° C./min and dwelled for another 1 h to ensure complete solvent removal. Finally, the 1.1 μm thick sulfide glass film was naturally cooled to room temperature in an N₂ glove box.

### I.4 EXAMPLE 4 (COMPARATIVE)

A 70Li₂S.30P₂S₅ powder of Example 1 was dissolved in anhydrous ethanol (EtOH), instead of MeOH then drop-casted and dried all according to the Example 3.

### I.5 EXAMPLE 5

Various thin films comprising a solid electrolyte were prepared by drop-casting solutions of (Li₂S)_{0.7} (P₂S₅)_{0.3} in N-methylformamide onto cleaned and pre-heated Au/Si wafers as a substrate according to the Example 1. Table 1 shows the corresponding NMF based precursor solutions and the conditions under which the thin Li ion conducting films were formed, together with the results of conductivity evaluation. Sample No. 7 is for comparison, in which the substrate was heated to the temperature of 120° C.

II. Electrochemical Characterization of Thin Films of (Li₂S)_{0.7}(P₂S₅)_{0.3}

Room temperature electrochemical impedance spectroscopy (EIS) was performed in the range of 1 MHz to 1 Hz. To determine a total vertical conductivity 4 Au contacts were evaporated each 2×2 mm and 100 nm thickness. The total conductivity a was determined using the equation below, where R stands for the impedance of the layer received by fitting the measured data with a suitable equivalent circuit, I describes the layer thickness determined from SEM images and A describes the contact area. The fitting was performed with the program Gamry Echem Analyst using the simplex method.

$$σ = \frac{1}{R} \cdot \frac{l}{A}$$

Collected data of a sample of example 2 were fitted with a resistance parallel to a constant phase element in series with a second resistance parallel to a constant phase element in series with a third constant phase element (R₁Q₁)(R₂Q₂)Q₃, where R₁Q₁ and R₂Q₂ describe the layer whereas Q₃ describes the non-blocking behavior of the Au electrode.

Measured data of samples of examples 1, 3, 4 and 5 were fitted with a resistance parallel to a constant phase element in series with a second resistance parallel to a constant phase element (R₁Q₁)(R₂Q₂). In this case circuit R₁Q₁ describes the layer and R₂Q₂ stands for processes at the Si substrate and the sulfide layer interface, as the value of R₂ is high.

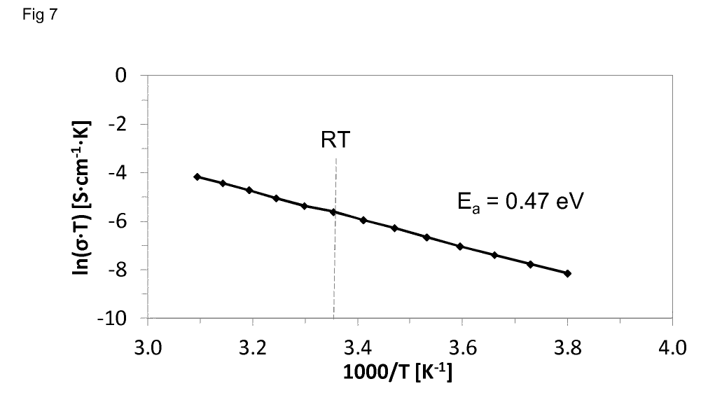

To determine the activation energy of the sample of Example 1 an Arrhenius plot was obtained within a temperature range of −10° C. and +50° C. and using the EIS frequency range from 1 MHz to 1 kHz. Impedance data were fitted using a (R₁Q₁)Q₂ equivalent circuit, where R₁Q₁ describes the layer and Q₂ stands for the blocking behaviour of the Au electrode. Activation energy of 470 meV was revealed from the slope of the linear fit in the Arrhenius diagram shown in FIG. 7.

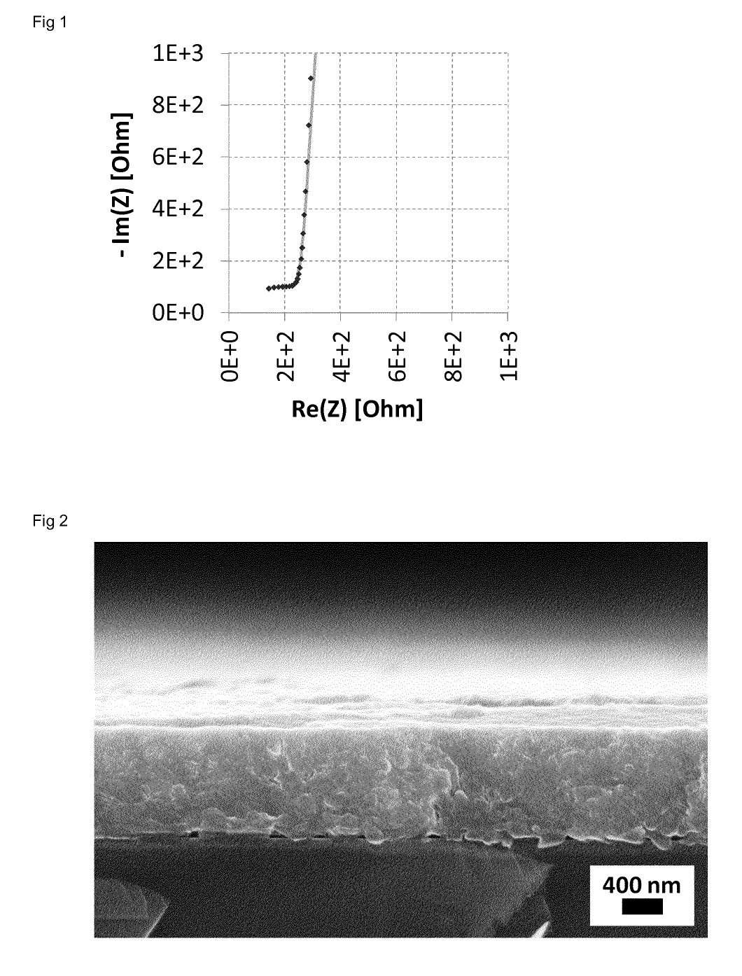

FIG. 1.: Nyquist plot of a sample of Example 1 (NMF—100° C. for 0.5 h—215° C. for 1 h): 9.69E-06 S/cm

FIG. 2.: SEM images of a sample of Example 1

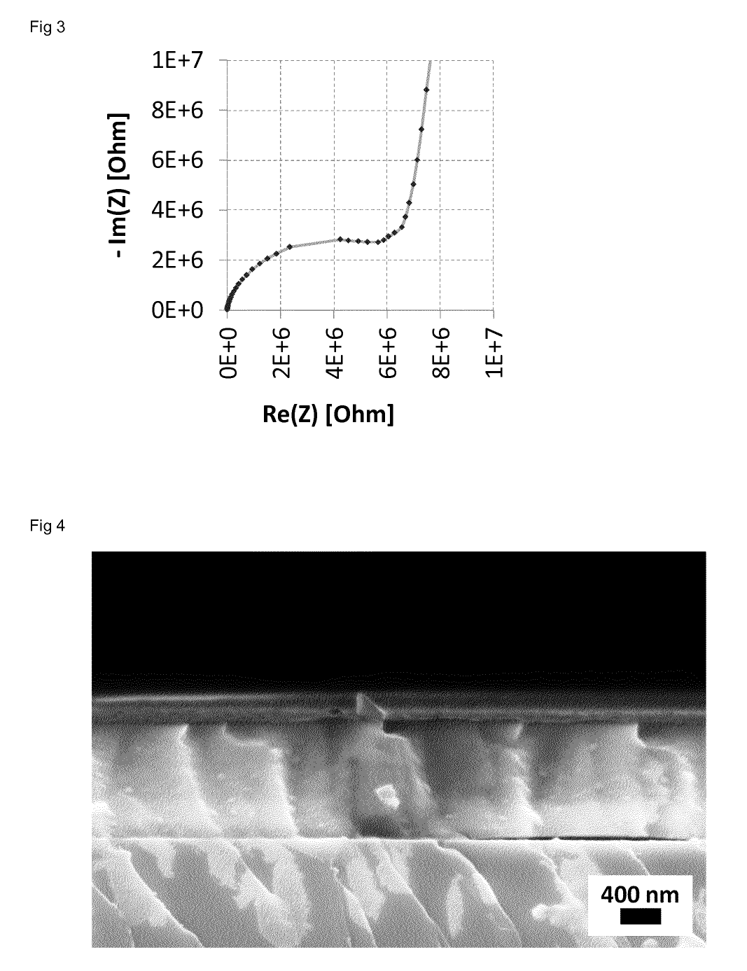

FIG. 3.: Nyquist plot of a sample of Example 2 (NMF—150° C. for 3 h): 7.93E-10 S/cm

FIG. 4.: SEM images of a sample of Example 2

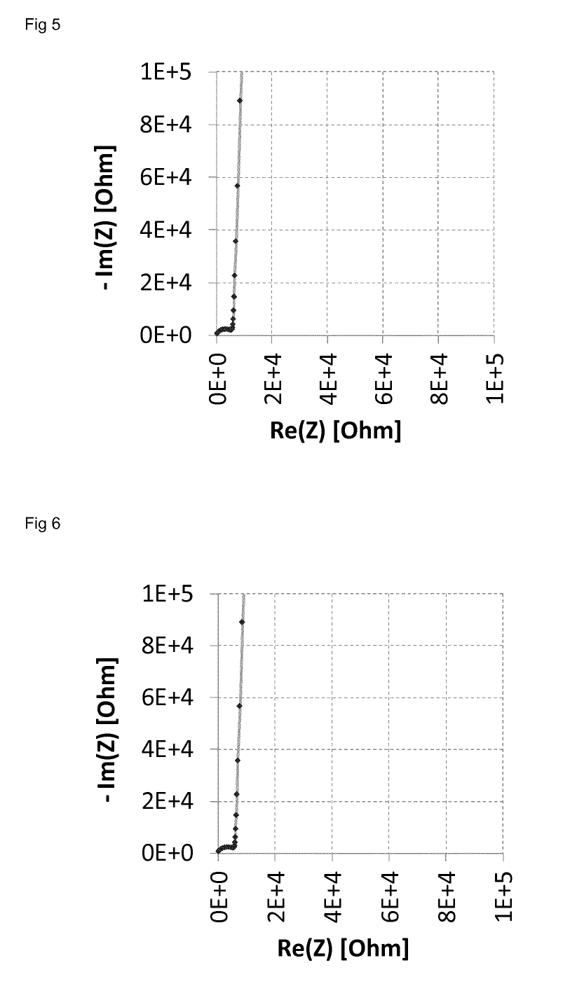

FIG. 5.: Nyquist plot of a sample of Example 3 (MeOH—215° C. for 1 h): 4.19E-07 S/cm

FIG. 6.: Nyquist plot of a sample of Example 4 (EtOH—215° C. for 1 h): 2.29E-07 S/cm

FIG. 7.: Arrhenius diagram of the sample of Example 1

TABLE 1
Results of Example 5

| | Ink | | Deposition & Pre-drying | Pre-drying | Heating | | Drying | |
|---|---|---|---|---|---|---|---|---|
| Sample | Concentration, | Ink Volume, | Temperature, | Time, | Ramp, | Drying Temperature, | Time, | Conductivity, |
| No. | wt. % | μL | ° C. | min | K/min | ° C. | min | S/cm |
| 1 | 4 | 6 | 60 | 30 | 10 | 225 | 60 | 2.30E−05 |
| 2 | 4 | 6 | 70 | 30 | 10 | 225 | 60 | 2.61E−05 |
| 3 | 4 | 6 | 80 | 30 | 10 | 225 | 60 | 2.73E−05 |
| 4 | 4 | 6 | 90 | 30 | 10 | 225 | 60 | 2.36E−05 |
| 5 | 4 | 6 | 100 | 30 | 10 | 225 | 60 | 1.69E−05 |
| 6 | 4 | 6 | 110 | 30 | 10 | 225 | 60 | 1.36E−05 |
| 7c | 4 | 6 | 120 | 30 | 10 | 225 | 60 | 1.15E−05 |
| 8 | 4 | 6 | 80 | 15 | 10 | 225 | 60 | 2.65E−05 |
| 9 | 4 | 6 | 80 | 60 | 10 | 225 | 60 | 2.69E−05 |
| 10 | 4 | 6 | 80 | 30 | 10 | 200 | 60 | 5.08E−06 |
| 11 | 4 | 6 | 80 | 30 | 10 | 225 | 60 | 2.39E−05 |
| 12 | 4 | 6 | 80 | 30 | 10 | 250 | 60 | 2.71E−05 |
| 13 | 4 | 6 | 80 | 30 | 10 | 275 | 60 | 2.97E−05 |
| 14 | 4 | 6 | 80 | 30 | 10 | 300 | 60 | 2.79E−05 |
| 15 | 4 | 6 | 80 | 30 | 10 | 275 | 30 | 2.70E−05 |
| 16 | 4 | 6 | 80 | 30 | 10 | 275 | 90 | 3.26E−05 |
| 17 | 4 | 6 | 80 | 30 | 10 | 275 | 120 | 3.25E−05 |
| 18 | 4 | 6 | 80 | 30 | 20 | 275 | 90 | 2.57E−05 |
| 19 | 4 | 6 | 80 | 30 | 5 | 275 | 90 | 3.77E−05 |
| 20 | 4 | 6 | 80 | 30 | 2 | 275 | 90 | 3.17E−05 |
| 21 | 4 | 2 | 80 | 30 | 5 | 275 | 90 | 4.71E−05 |
| 22 | 4 | 4 | 80 | 30 | 5 | 275 | 90 | 3.93E−05 |
| 23 | 4 | 6 | 80 | 30 | 5 | 275 | 90 | 3.13E−05 |
| 24 | 4 | 8 | 80 | 30 | 5 | 275 | 90 | 2.87E−05 |
| 25 | 2 | 4 | 80 | 30 | 5 | 275 | 90 | 1.27E−05 |
| 26 | 6 | 4 | 80 | 30 | 5 | 275 | 90 | 5.02E−05 |
| 27 | 8 | 4 | 80 | 30 | 5 | 275 | 90 | 6.18E−05 |

1. A process for preparing a thin film comprising a solid electrolyte, which comprises lithium and sulfur, comprising the process steps of
a) forming a layer by depositing of a liquid mixture, which comprises one or more compounds, which comprise together lithium and sulfur, and at least one organic solvent, on a substrate, which is heated to a temperature in the range from 50° C. to 110° C.,
b) keeping the formed layer of process step a) at a temperature in the range from 50° C. to 110° C. for a period in the range from 0.1 h to 24 h, and
c) heating the layer obtained in process step b) at a temperature in the range from 180° C. to 400° C. for a period in the range from 0.5 h to 24 h.

2. The process according to claim 1, wherein the thin film has a thickness in the range from 5 nm to 50 μm.

3. The process according to claim 1, wherein the solid electrolyte, which comprises lithium and sulfur, is defined by general formula (I)
(Li₂Sₛ)ₓ(LiₙXⁿ⁻)ᵥ(P₂Sₜ₋ᵤOᵤ)O_{y}(M^{m+}ₒZ^{o-}ₘ)_{w} (I)
in which the variables are each defined as follows:
M is an element of group 2, group 4, group 8, group 12 or group 13 of the periodic table or Si, Ge, Sn, Pb, As, Sb or Bi or a mixture thereof,
X is N, O, a halogen or a mixture thereof,
Z is N, O, S, a halogen or a mixture thereof,
m is 2, 3, 4 or 5 in case of a single element M in a single oxidation state or a rational number in the range from 2 to 5 calculated on basis of different oxidation states of different elements M and a molar ratio of said different elements M,
n is 1 for halogen, 2 for O (oxygen) or 3 for N (nitrogen) or a rational number in the range from 1 to 3 calculated on basis of a molar ratio of said different elements X,
o is 1 for halogen, 2 for O (oxygen), 2 for S (sulfur) or 3 for N (nitrogen) or a rational number in the range from 1 to 3 calculated on basis of a molar ratio of said different elements Z,
s is a rational number from 1 to 8,
t is a rational number from 0.5 to 5,
u is a rational number from 0 to t,
x is in the range from 0.05 to 0.95,
y is in the range from 0 to 0.95,
is in the range from 0 to 0.95,
w is in the range from 0 to 0.95,
wherein x+y+v+w=1.

4. The process according to claim 1, wherein the solid electrolyte, which comprises lithium and sulfur, further comprises phosphorous.

5. The process according to claim 1, wherein the solid electrolyte, which comprises lithium and sulfur, further comprises nitrogen, oxygen or a halogen.

6. The process according to claim 1, wherein the deposition of the liquid mixture in process step a) is done by inkjet printing.

7. The process according claim 1, wherein the at least one organic solvent is N-methylformamide.

8. The process according to claim 1, wherein the liquid mixture, which is deposited in process step a), is a solution.

9. The process according to claim 1, wherein the temperature of process step c) is reached by a heating rate in the range from 2 K/min to 50 K/min.

10. The process according to claim 1, wherein the layer is kept at a pressure in the range from 10 kPa to 200 kPa during process steps a), b) and c).
